(19) United States
(12) Patent Application Publication
(10) Pub. No.: US 2008/0077495 A1
(43) Pub. Date: Mar. 27, 2008

(54) SYSTEM FOR AN ONLINE COMMUNITY

(76) Inventors: Richard Scully, Quincy, CA (US); Brian Thompson, Quincy, CA (US); Ronald A. Flint, (US); Jim Etherington, (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/859,660

(22) Filed: Sep. 21, 2007

Related U.S. Application Data
(60) Provisional application No. 60/826,726, filed on Sep. 22, 2006.

(51) Int. Cl. G06Q 30/00; G06Q 40/00

(52) U.S. Cl. 705/14; 705/1; 705/39

(57) ABSTRACT

A system for an online community provides linkage between a plurality of business entities and a population of computer-literate individuals to develop online capabilities for the business entities. A server is attached to a network accessible to the business entities and the individuals. Synchronization software runs on the server and is configurable by the individuals to provide the desired online capabilities. Development of the online capabilities provides a work environment for the individuals. Access to the business entities is through an association, such as a chamber of commerce. A manager from the association administers the developed online community, connecting an organization, such as a school, with the association. The organization provides access to the individuals and a framework for fund-raising programs to benefit the organization and the individuals. The system routes fund handling and delivery of goods or services generated by the online capabilities to the business entities for processing.

### RELATED APPLICATION

This non-provisional application claims priority from provisional application Ser. No. 60/826,726 filed Sep. 22, 2006.

### FIELD OF INVENTION

This invention relates to the field of online commerce, and more specifically to a system for developing an online commercial community using an established business base and an available knowledge base for computerized implementation.

### BACKGROUND OF THE INVENTION

With the Internet and electronic commerce playing an ever-larger role in the modem economy, many businesses have become aware that their future success will depend upon having an effective online presence. Unfortunately, many businessmen do not have the necessary knowledge of present day computer systems and networks needed to develop such systems, nor do they have the time to develop such knowledge. There are, however, many members of the student community that have grown up with computers and who have the skills needed to develop effective online business systems. These students would benefit greatly from the opportunity to have steady work of a professional nature available for them to perform as fits with their academic schedules. The present invention provides systems for drawing upon this computer and network knowledge resource while providing a valuable service to local businesses. The result is a growing online community based upon local businesses and resident knowledge of computer systems and networks. Often, the development of these systems can provide fund-raising opportunities for the schools involved.

U.S. Patent Application No. 2005/0165620, published for Sturm et al., discloses a a fundraising system, program product, and associated methods. This method includes enrolling a plurality of schools and vendors as participants in a charitable program, providing each of the participant plurality of primary and secondary schools a designator to identify each particular primary and secondary school participating in the charitable program, attaching at least one designator to transactions by each of the plurality of participant vendors, providing a sales incentive for each of the transactions having at least one designator attached thereto, and reporting the sales incentives provided and transactions with at least one participant school attached thereto reported by the vendor to an administrative server.

The schools can agree to promote the products and services within the local communities. Companies advantageously agree to return monthly or quarterly revenue, based on earned income from the services to new or renewing customers, to individual schools, and districts. Income may be generated in the form of percentages of monthly sales, flat amounts added on as monthly fees to support the school, or amounts contributed by the customer and matched on a percentage basis by the company.

U.S. Patent Application No. 2005/0108113, published for Wittsche is directed stores in an on-line mall with common facade. The method provides multiple communities within an on-line mall environment. Multiple stores are provided within each of the multiple communities, with each store being associated with a merchant with merchandise directed to its community. The on-line mall website is functionally partitioned into communities. For the purposes of this application, a community is a series of stores, which are targeted to a specific demographic market. Examples include, but are not limited to, apparel stores for women, men, children, and teens. A store manager server is provided and includes store manager data and a store manager graphical interface. The store manager data includes information such as merchandise available at the store and specific merchandise pricing data. The community web server includes several community functions including, by way of example, a directory of all stores, search capabilities, a help desk, and various other community functions.

The customer may communicate directly with the merchant or alternatively, the customer communicates with a licensed distributor of the merchant's product 408, not the actual merchant. An example of a licensed distributor may include a retail outlet for furniture, wherein the retail outlet purchases the furniture from the manufacturer and then directly sells the furniture to a customer. The customer may access the manufacturer's website and buy directly from the manufacturer, or the customer may access a licensed distributor and purchase the furniture through a licensed distributor.

U.S. Patent Application No. 2002/0116214, published for Horn an automated fundraising accounting system. This system includes the processes of a purchaser selecting a beneficiary and a merchant predefining a donation percentage. The selected beneficiary and the predefined donation percentage are received by a processor. The purchaser's transaction amount is tracked; the predefined donation percentage of the transaction amount (i.e., the donation amount) is donated from the merchant to the beneficiary. Optionally, electronic fund transfer is used to transfer the donation amount from a bank account of the merchant to a bank account of the beneficiary.

U.S. Patent Application No. 2002/0116215, published for Lawrence et al. disclose a method and system for administering an on-line fund-raising event. This system includes a fund-raising method and system relating to the planning and administration of fund-raising events such as live auctions, on-line sales, and on-line auction events. In a preferred aspect, a centralized Web site accessible by network users is provided and maintained for hosting on-line fund-raising auctions of goods or services in the name of fund-raising entities, where the goods or services are not owned or provided by the fund-raising entities, and preferably are provided or owned by the host of the fundraising event or host of the Web site. The goods or services are auctioned to users visiting the Web site, payment from a user successfully bidding on a good or service for auction is received and a portion of the payment preferably is allocated to the fund-raising entity. A rebate may be provided to the fund-raising organization proportional to a total amount of revenue generated during a fund-raising event, the rebate may be applicable to the cost of future fund-raising events.

U.S. Patent Application No. 2006/0155610, published for Neville et al. is directed to a transaction portal system. This system includes a transaction processing portal that is in network communication with and serves separate and distinct vendors that each have multiple corresponding customers. A transaction client system is associated with each of the multiple customers of each vendor. The transaction client system of each customer is in networked communication with one or more devices of the customer (e.g., computer printers) that are serviced by the vendor. The devices provide to the transaction client system via network communication a supply or service notification of a supply or service requirement of the device. The supply or service notification may include a device identifier and a device type identifier. The transaction client system sends the supply or service notification to the transaction processing portal over an external public network, such as the Internet, and the transaction processing portal forwards the supply or service notification to the vendor.

It is an objective of the present invention to provide a system to assist local businesses to develop an automated online presence based upon their existing businesses. It is a further objective to provide such a system that will provide steady and predictable employment for a local student population. It is a still further objective of the invention to provide such employment in the field of computer and business development skills that will provide transferable knowledge for the students. It is yet a further objective to provide a system adaptable to fund raising programs. Finally, it is an objective of the present invention to provide such business development systems in a form that is transferable to other environments such as prisons or homes for the disabled.

While some of the objectives of the present invention are disclosed in the prior art, none of the inventions found include all of the requirements identified.

### SUMMARY OF THE INVENTION

The present invention addresses all of the deficiencies of prior art systems for online community inventions and satisfies all of the objectives described above.

(1) A system for an online community providing the desired features may be constructed from the following components. A plurality of business entities is provided. A population of computer-literate individuals is provided. At least one server is provided. The server is attached to a network accessible to the business entities and the individuals. Synchronization software is provided. The software runs on the at least one server and is configurable by the individuals to provide online capabilities to the business entities. Development of the online capabilities provides a work environment for the individuals.

(2) In a variant of the invention, at least one association is provided. The association provides access to the business entities.

(3) In another variant, the association provides at least one manager. The manager administers the online community.

(4) In yet another variant, at least one organization is provided. The organization provides access to the population of computer-literate individuals.

(5) In still another variant, the organization provides at least one representative. The representative organizes and controls the population of computer-literate individuals.

(6) In a further variant, at least one fund-raising program is provided. The fund-raising program is developed for the benefit of the organization.

(7) In still a further variant, the at least one fund-raising program is managed by at least one representative.

(8) In another variant of the invention, an approval program is provided. The approval program uses the server and the network to solicit permission for the population of computer-literate individuals to participate in the online community.

(9) In yet another variant, at least one member of the population of computer-literate individuals is assigned responsibility for implementing online business capabilities for each of the business entities.

(10) In still another variant, the at least one member will work with an owner of the business entity to develop at least one online catalogue of either of goods and services offered by the entity.

(11) In a further variant, the online capabilities provided to the business entities further include transaction facilities. The transaction facilities includes features for any of accepting offers via e-mail, presenting either of goods and services on a web page, accepting orders via e-mail, protecting access to selected items on a web page, providing an on-sale banner, accepting reservation requests, accepting appointment requests, offering coupons on a web page, accepting an inquiry for an item offered on a web page, accepting online employment applications and presenting items offered on a web page in a classified format.

(12) In still a further variant, a member of the population of computer-literate individuals selects at least one of the business entities to promote online in support of at least one fund-raising program.

(13) In yet a further variant, a member of the population of computer-literate individuals adds either goods or services to an online capability developed for the at least one business entity.

(14) In another variant of the invention, a reporting facility is provided. The facility is used by the at least one manager administering the online community to provide performance data to the members of the population of computer-literate individuals to improve performance of the online capabilities.

(15) In yet another variant, the at least one member develops at least one additional online capability to sell either goods or services offered in the catalogue by the business entity to the community.

(16) In still another variant, orders received through the at least one additional online capability for a fund-raising program are sent to the business entity for processing.

(17) In a further variant, receipt of payments and either shipment of goods or provision of services are handled by the business entity.

(18) In still a further variant, the system notifies either the member or a person approving actions of the member of a successful transaction.

(19) In yet a further variant, the system notifies the association of funds owed by business entities due to fund-raising activities.

(20) In another variant of the invention, funds are collected by the system and transferred to the fund-raising activities while clearing at least one accounts receivable entry from the system.

(21) In yet another variant, a member developing at least one online catalogue receives a rating related to catalogue development skills. The rating is maintained by the system and available for review by the business entities seeking development of online catalogues.

(22) In still another variant, a member developing at least one online catalogue develops a catalogue of either goods or services associated with the member that are drawn from catalogues of the business entities for whom the member has developed the catalogues.

(23) In a further variant, an online photo center is provided. The photo center provides photos to the members developing the online catalogues and provides a photo monitoring feature. The monitoring feature reviews the online catalogues to determine if items within the catalogues require photos and advises the members developing the catalogues of the photo requirements.

(24) In still a further variant, users of the system pay a periodic fee. The fee is determined by a level of service provided to the user by the system.

(25) In a final variant of the invention, the reporting facility further includes reports allocating payments received by the system between any of a fund raising program, the manager, any of the members associated with receipt the payment, a general fund, a non-profit entity outside of the community and a service provider.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a schematic view of the preferred embodiment of the invention;

FIG. 2 is a schematic view of an online presence provided by the FIG. 1 embodiment;

FIG. 3 is a schematic view of a student's online catalogue;

FIG. 4 is a flow chart of the system's online report generation facility;

FIG. 5 is a flow chart of typical commerce paths provided under the system;

FIG. 6 is a flow chart of the photo center service operations of the system;

FIG. 7 is a flow chart of the payment allocation operations of the system;

FIG. 8 is a table illustrating a typical payment schedule for access to the system; and

FIG. 9 is a table illustrating ratings for catalogue development skills.

### DETAILED DESCRIPTION OF THE PREFERRED EMBODIMENT

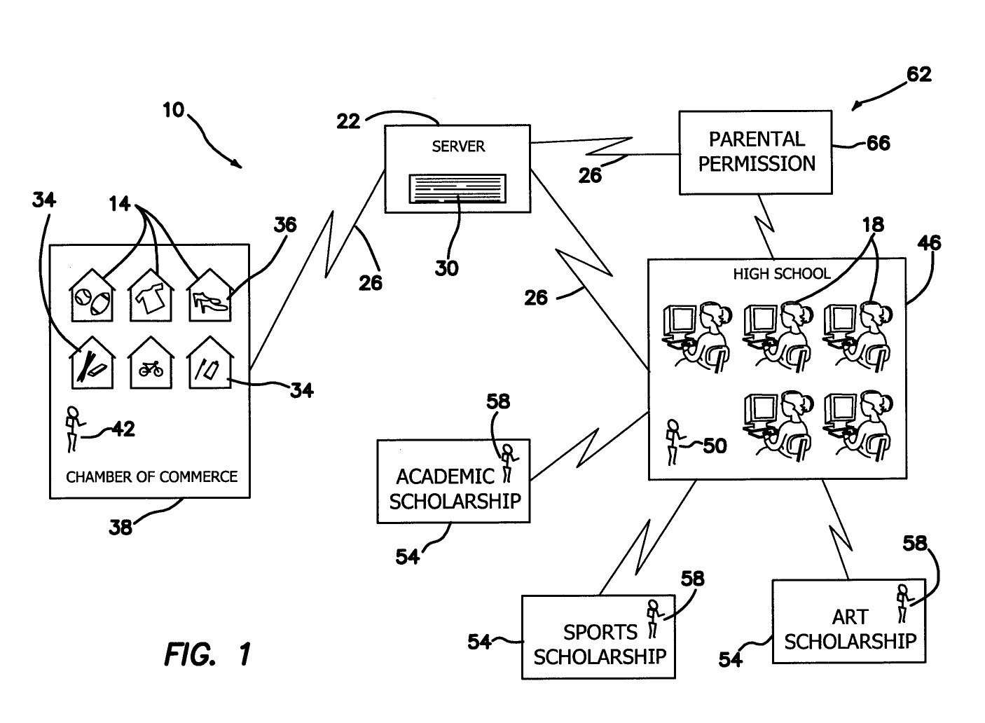

(1) FIGS. 1-9 illustrate a system for an online community 10 providing the desired features that may be constructed from the following components. As illustrated in FIG. 1, a plurality of business entities 14 is provided. A population of computer-literate individuals 18 is provided. At least one server 22 is provided. The server 22 is attached to a network 26 accessible to the business entities 14 and the individuals 18. Synchronization software 30 is provided. The software 30 runs on the at least one server 22 and is configurable by the individuals 18 to provide online capabilities 34 to the business entities 14. Development of the online capabilities 34 provides a work environment 36 for the individuals 18.

(2) In a variant of the invention, at least one association 38 is provided. The association 38 provides access to the business entities 14.

(3) In another variant, the association 38 provides at least one manager 42. The manager 42 administers the online community 10.

(4) In yet another variant, at least one organization 46 is provided. The organization 46 provides access to the population of computer-literate individuals 18.

(5) In still another variant, the organization 46 provides at least one representative 50. The representative 50 organizes and controls the population of computer-literate individuals 18.

(6) In a further variant, at least one fund-raising program 54 is provided. The fund-raising program 54 is developed for the benefit of the organization 46.

(7) In still a further variant, the at least one fund-raising program 54 is managed by at least one representative 58.

(8) In another variant of the invention, an approval program 62 is provided. The approval program 62 uses the server 22 and the network 26 to solicit permission 66 for the population of computer-literate individuals 18 to participate in the online community 10.

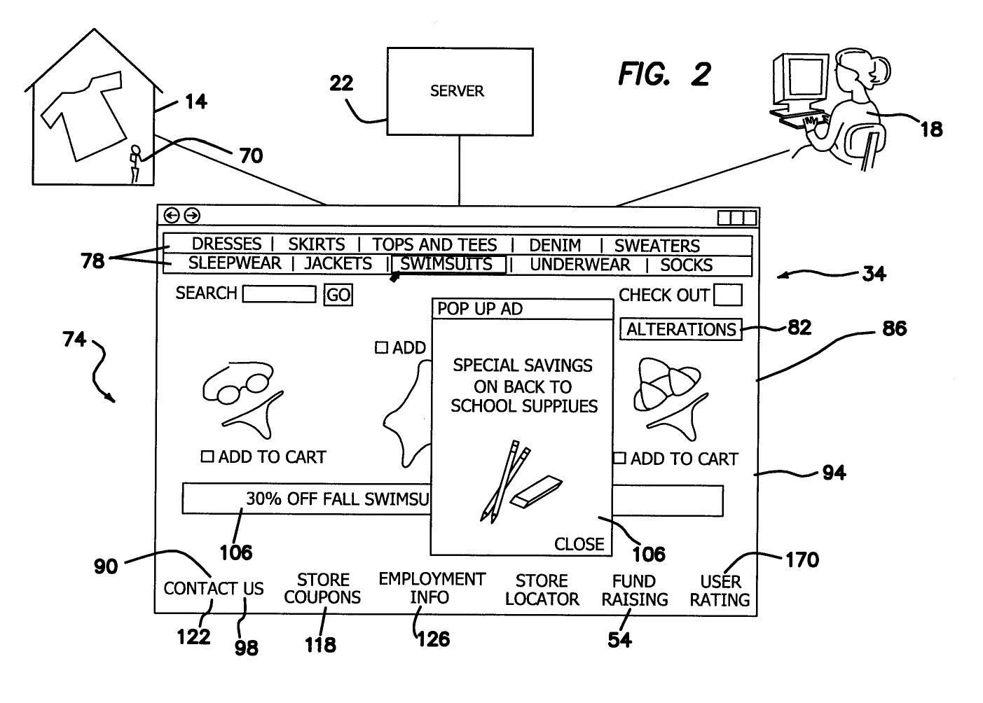

(9) In yet another variant, as illustrated in FIG. 2, at least one member of the population of computer-literate individuals 18 is assigned responsibility for implementing online business capabilities 34 for each of the business entities 14.

(10) In still another variant, the at least one member 18 will work with an owner 70 of the business entity 14 to develop at least one online catalogue 74 of either of goods 78 and services 82 offered by the entity 14.

(11) In a further variant, the online capabilities 34 provided to the business entities 14 further include transaction facilities 86. The transaction facilities 86 includes features for any of accepting offers via e-mail 90, presenting either of goods and services on a web page 94, accepting orders via e-mail 98, protecting access to selected items on a web page (not shown), providing an on-sale banner 106, accepting reservation requests (not shown), accepting appointment requests (not shown), offering coupons on a web page 118, accepting an inquiry for an item offered on a web page 122, accepting online employment applications 126 and presenting items offered on a web page in a classified format (not shown).

(12) In still a further variant, a member of the population of computer-literate individuals 18 selects at least one of the business entities 14 to promote online in support of at least one fund-raising program 54.

(13) In yet a further variant, a member of the population of computer-literate individuals 18 adds either goods 78 or services 82 to an online capability 34 developed for the at least one business entity 14.

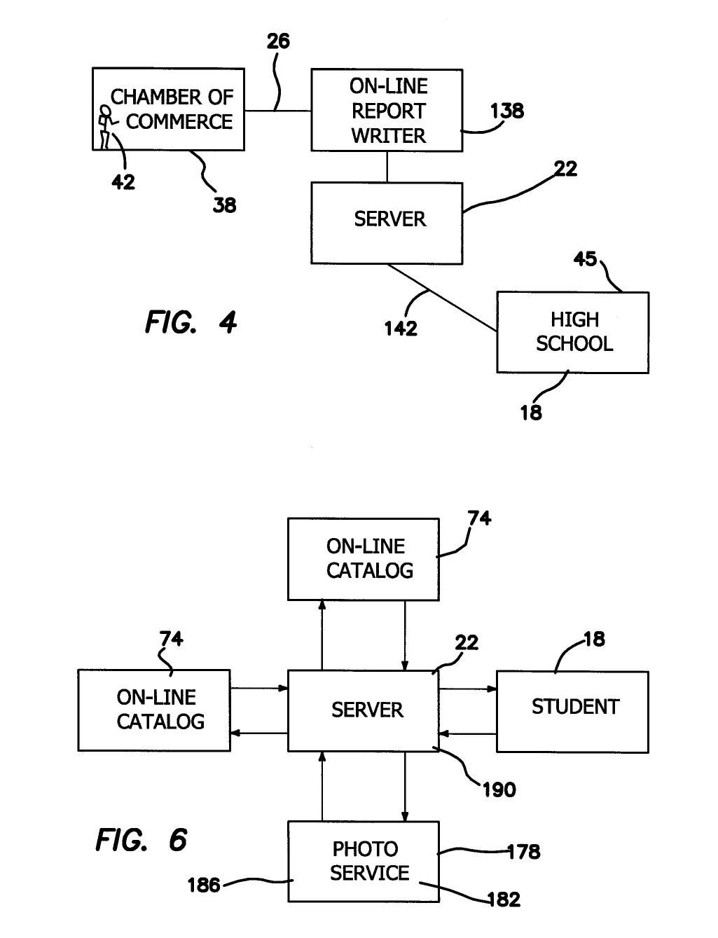

(14) In another variant of the invention, as illustrated in FIG. 4, a reporting facility 138 is provided. The facility 138 is used by the at least one manager 42 administering the online community 10 to provide performance data 142 to the members of the population of computer-literate individuals 18 to improve performance of the online capabilities 34.

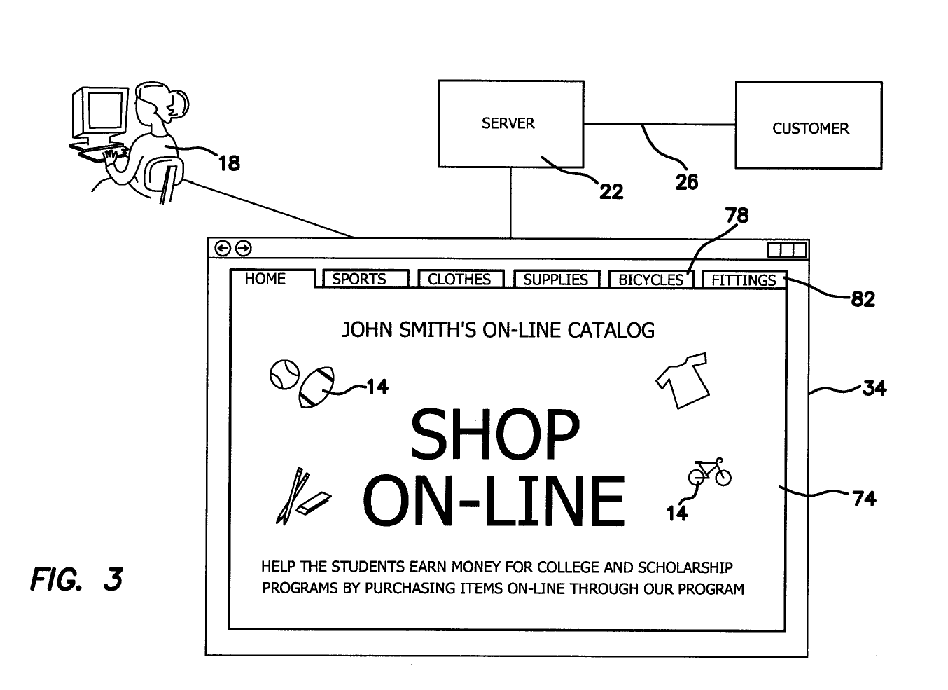

(15) In yet another variant, as illustrated in FIG. 3, the at least one member 18 develops at least one additional online capability 34 to sell either goods 78 or services 82 offered in the catalogue 74 by the business entity 14 to the community 10.

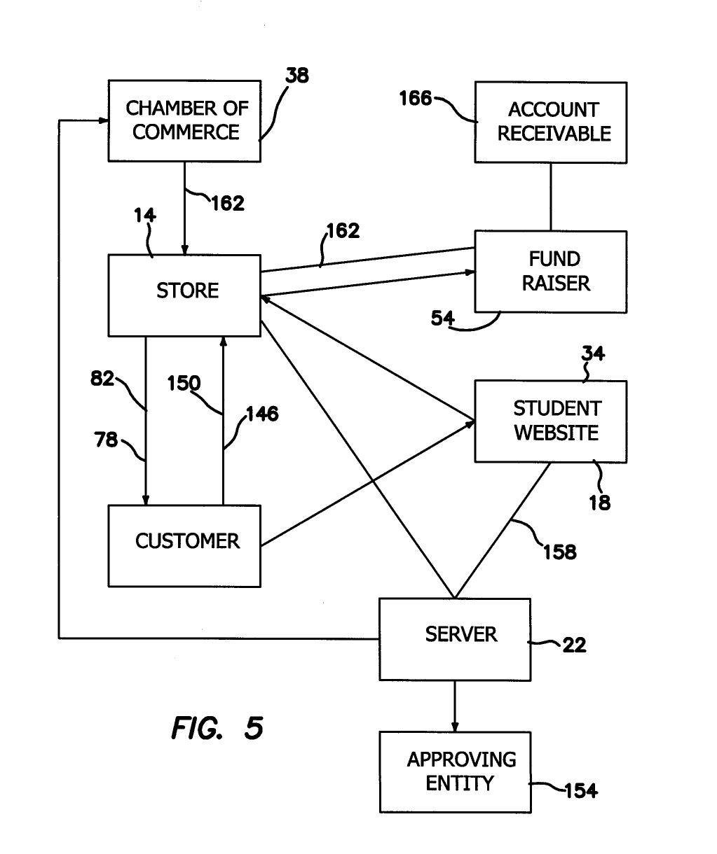

(16) In still another variant, as illustrated in FIG. 5, orders 146 received through the at least one additional online capability 34 for a fund-raising program 54 are sent to the business entity 14 for processing.

(17) In a further variant, receipt of payments 150 and either shipment of goods 78 or provision of services 82 are handled by the business entity 14.

(18) In still a further variant, the system 10 notifies either the member 18 or a person approving actions of the member 154 of a successful transaction 158.

(19) In yet a further variant, the system 10 notifies the association 38 of funds 162 owed by business entities 14 due to fund-raising programs 54.

(20) In another variant of the invention, funds 162 are collected by the system 10 and transferred to the fund-raising programs 54 while clearing at least one accounts receivable entry 166 from the system 10.

(21) In yet another variant, as illustrated in FIG. 9, a member 18 developing at least one online catalogue 74 receives a rating 170 related to catalogue development skills 174. The rating 170 is maintained by the system 10 and available for review by the business entities 14 seeking development of online catalogues 74.

(22) In still another variant, as illustrated in FIG. 3, a member 18 developing at least one online catalogue 74 develops a catalogue 74 of either goods 78 or services 82 associated with the member 18 that are drawn from catalogues 74 of the business entities 14 for whom the member 18 has developed the catalogues 74.

(23) In a further variant, as illustrated in FIG. 6, an online photo center 178 is provided. The photo center 178 provides photos 182 to the members 18 developing the online catalogues 74 and provides a photo monitoring feature 186. The monitoring feature 186 reviews the online catalogues 74 to determine if items within the catalogues 74 require photos 182 and advises the members 18 developing the catalogues 74 of the photo requirements 190.

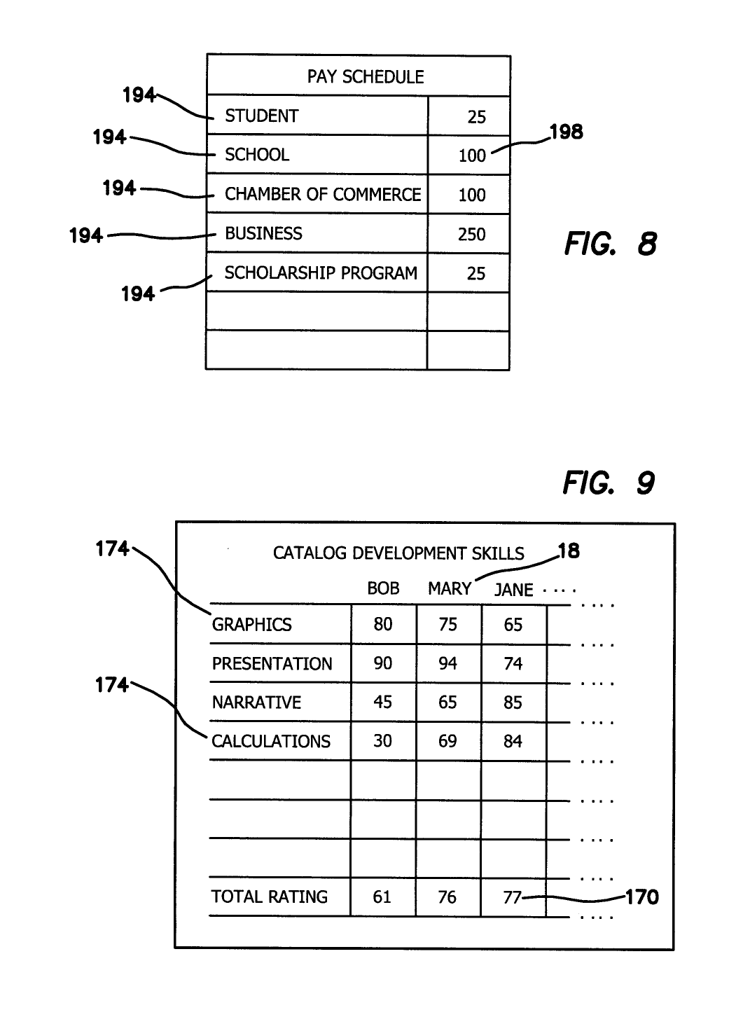

(24) In still a further variant, as illustrated in FIG. 8, users 194 of the system 10 pay a periodic fee 198. The fee 198 is determined by a level of service (not shown) provided to the user 194 by the system 10.

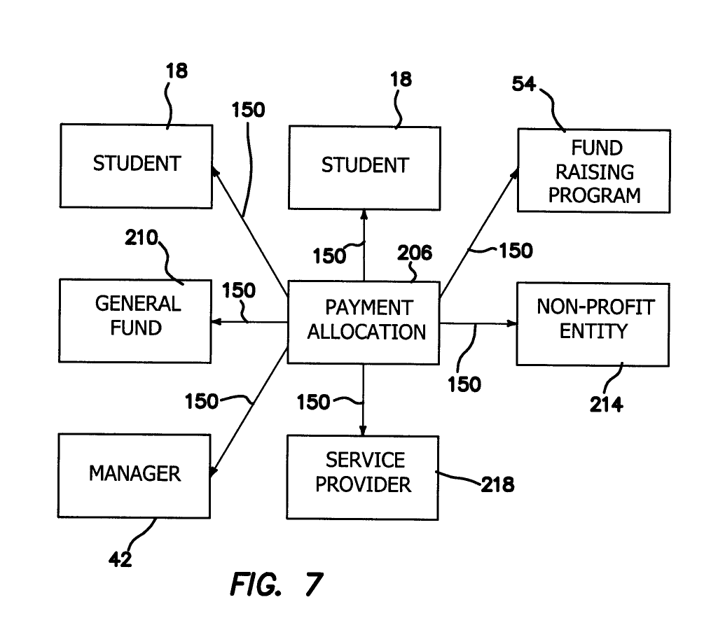

(25) In a final variant of the invention, as illustrated in FIG. 7, the reporting facility 138 further includes reports 206 allocating payments 150 received by the system 10 between any of a fund raising program 54, the manager 42, any of the members 18 associated with receipt the payment 150, a general fund 210, a non-profit entity outside of the community 214 and a service provider 218.

The system for an online community 10 has been described with reference to particular embodiments. Other modifications and enhancements can be made without departing from the spirit and scope of the claims that follow.

1. A system for an online community comprising:
a plurality of business entities;
a population of computer-literate individuals;
at least one server, said server attached to a network accessible to said business entities and said individuals;
synchronization software, said software running on said at least one server and being configurable by said individuals to provide online capabilities to said business entities;
development of said online capabilities providing a work environment for said individuals.

2. The system for an online community, as described in claim 1, further comprising at least one association, said association providing access to said business entities.

3. The system for an online community, as described in claim 2, wherein said association provides at least one manager, said manager administering said online community.

4. The system for an online community, as described in claim 1, further comprising at least one organization, said organization providing access to said population of computer-literate individuals;

5. The system for an online community, as described in claim 4, wherein said organization provides at least one representative, said representative organizing and controlling said population of computer-literate individuals.

6. The system for an online community, as described in claim 1, further comprising at least one fund-raising program, said fund-raising program developed for the benefit of said organization.

7. The system for an online community, as described in claim 6, wherein said at least one fund-raising program is managed by at least one representative.

8. The system for an online community, as described in claim 1, further comprising an approval program, said approval program using said server and said network to solicit permission for said population of computer-literate individuals to participate in said online community.

9. The system for an online community, as described in claim 1, wherein at least one member of said population of computer-literate individuals is assigned responsibility for implementing online business capabilities for each of said business entities.

10. The system for an online community, as described in claim 9, wherein said at least one member will work with an owner of said business entity to develop at least one online catalogue of either of goods and services offered by said entity.

11. The system for an online community, as described in claim 1, wherein said online capabilities provided to said business entities further comprise transaction facilities, said transaction facilities comprising features for any of:
accepting offers via e-mail;
presenting either of goods and services on a web page;
accepting orders via e-mail;
protecting access to selected items on a web page;
providing an on-sale banner;
accepting reservation requests;
accepting appointment requests;
offering coupons on a web page;
accepting an inquiry for an item offered on a web page;
accepting online employment applications; and
presenting items offered on a web page in a classified format.

12. The system for an online community, as described in claim 12, wherein a member of said population of computer-literate individuals selects at least one of said business entities to promote online in support of at least one fund-raising program.

13. The system for an online community, as described in claim 1, wherein a member of said population of computer-literate individuals adds either of goods and services to an online capability developed for said at least one business entity.

14. The system for an online community, as described in claim 3, further comprising a reporting facility, said facility used by said at least one manager administering said online community to provide performance data to said members of said population of computer-literate individuals to improve performance of said online capabilities.

15. The system for an online community, as described in claim 10, wherein said at least one member develops at least one additional online capability to sell either of goods and services offered in said catalogue by said business entity to said community.

16. The system for an online community, as described in claim 15, wherein orders received through said at least one additional online capability for a fund-raising program are sent to said business entity for processing.

17. The system for an online community, as described in claim 16, wherein receipt of payments and either of shipment of goods and provision of services is handled by said business entity.

18. The system for an online community, as described in claim 17, wherein said system notifies either of said member and a person approving actions of said member of a successful transaction.

19. The system for an online community, as described in claim 2, wherein said system notifies said association of funds owed by business entities due to fund-raising activities.

20. The system for an online community, as described in claim 19, wherein said funds are collected by said system and transferred to said fund-raising programs while clearing at least one accounts receivable entry from said system.

21. The system for an online community, as described in claim 10, wherein said at least one member developing said at least one online catalogue receives a rating related to catalogue development skills, said rating maintained by said system and available for review by said business entities seeking development of said online catalogues.

22. The system for an online community, as described in claim 10, wherein said at least one member developing said at least one online catalogue develops a catalogue of either of goods and services associated with said member and drawn from catalogues of said business entities for whom said members have developed said catalogues.

23. The system for an online community, as described in claim 10, further comprising an online photo center, said photo center providing photos to said members developing said online catalogues and providing a photo monitoring feature, said monitoring feature reviewing said online catalogues to determine if items within said catalogues require photos and advising said members developing said catalogues of said photo requirements.

24. The system for an online community, as described in claim 1, wherein users of said system pay a periodic fee, said fee being determined by a level of service provided to said user by said system.

25. The system for an online community, as described in claim 14, wherein said reporting facility further comprises reports allocating payments received by said system between any of a fund raising program, said manager, any of said members associated with receipt said payment, a general fund, a non-profit entity outside of said community and a service provider.
